(19) United States
(12) Patent Application Publication
(10) Pub. No.: US 2024/0094804 A1
(43) Pub. Date: Mar. 21, 2024

(54) WEARABLE ELECTRONIC DEVICES FOR COOPERATIVE USE

(71) Applicant: Apple Inc., Cupertino, CA (US)

(72) Inventors: Paul X. WANG, Cupertino, CA (US); Jeremy C. FRANKLIN, San Francisco, CA (US)

(21) Appl. No.: 18/232,296

(22) Filed: Aug. 9, 2023

Related U.S. Application Data
(60) Provisional application No. 63/407,122, filed on Sep. 15, 2022.

(51) Int. Cl. G06F 3/01; G02B 27/01

(52) U.S. Cl. CPC G06F 3/011; G02B 27/0101; G06F 3/017; G02B 2027/0138

(57) ABSTRACT

Systems of the present disclosure can provide head-mountable devices with different input and output capabilities. Such differences can lead the head-mountable devices to provide the corresponding users with somewhat different experiences despite operating in a shared environment. However, the outputs provided by one head-mountable device can be indicated on another head-mountable device so that the users are aware of the characteristics of each other's experience. Where different head-mountable devices provide different sensing capabilities, the sensors of one head-mountable device can contribute to the detections of the other to provide more accurate and detailed outputs, such as object recognition, avatar generation, hand and body tracking, and the like.

### CROSS-REFERENCE TO RELATED APPLICATION

This application claims the benefit of U.S. Provisional Application No. 63/407,122, entitled “WEARABLE ELECTRONIC DEVICES FOR COOPERATIVE USE,” filed Sep. 15, 2022, the entirety of which is incorporated herein by reference.

### TECHNICAL FIELD

The present description relates generally to head-mountable devices, and, more particularly, to cooperative uses of head-mountable devices with different features.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a first head-mountable device, according to some embodiments of the present disclosure.

FIG. 2 illustrates a top view of a second head-mountable device, according to some embodiments of the present disclosure.

FIG. 3 illustrates a top view of head-mountable device on users, according to some embodiments of the present disclosure.

FIG. 4 illustrates a second head-mountable device displaying an example graphical user interface, according to some embodiments of the present disclosure.

FIG. 5 illustrates a first head-mountable device displaying an example graphical user interface with indicators based on the second head-mountable device, according to some embodiments of the present disclosure.

FIG. 6 illustrates a first head-mountable device displaying an example graphical user interface with a view based on the second head-mountable device of FIG. 4, according to some embodiments of the present disclosure.

FIG. 7 illustrates a flow chart for a process having operations performed by a second head-mountable device, according to some embodiments of the present disclosure.

FIG. 8 illustrates a flow chart for a process having operations performed by a first head-mountable device, according to some embodiments of the present disclosure.

FIG. 9 illustrates a front view of a first head-mountable device on a first user, according to some embodiments of the present disclosure.

FIG. 10 illustrates a second head-mountable device displaying an example graphical user interface including an avatar of a first user, according to some embodiments of the present disclosure.

FIG. 11 illustrates a flow chart for a process having operations performed by a first head-mountable device, according to some embodiments of the present disclosure.

FIG. 12 illustrates a flow chart for a process having operations performed by a second head-mountable device, according to some embodiments of the present disclosure.

FIG. 13 illustrates a front view of a second head-mountable device on a second user and a first head-mountable device, according to some embodiments of the present disclosure.

FIG. 14 illustrates a first head-mountable device displaying an example graphical user interface including an avatar of a second user, according to some embodiments of the present disclosure.

FIG. 15 illustrates a flow chart for a process having operations performed by a first head-mountable device, according to some embodiments of the present disclosure.

FIG. 16 illustrates a side view of head-mountable devices on users, according to some embodiments of the present disclosure.

FIG. 17 illustrates a flow chart for a process having operations performed by a second head-mountable device, according to some embodiments of the present disclosure.

FIG. 18 illustrates a flow chart for a process having operations performed by a first head-mountable device, according to some embodiments of the present disclosure.

FIG. 19 illustrates a block diagram of head-mountable devices, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that is determined by the components (e.g., sensors, circuitry, and other hardware) included with the wearable device as manufactured. However, space, cost, and other considerations may limit the ability to provide every component that might provide a desired function. For example, different users may wear and operate different head-mountable devices that provide different components and functions. Nonetheless, users of different types of devices can participate jointly in a shared, collaborative, and/or cooperative activity.

Given the diversity of desired components and functions across different head-mountable devices, it would be beneficial to provide functions that help users understand each other's experience. This can allow the users to have more similar experiences while operating in a shared environment.

It can also be beneficial to allow multiple head-mountable devices to operate in concert to leverage their combined sensory input and computing power, as well as those of other external devices to improve sensory perception, mapping ability, accuracy, and/or processing workload. For example, sharing sensory input between multiple head-mountable devices can complement and enhance individual units by interpreting and reconstructing objects, surfaces, and/or an external environment with perceptive data from multiple angles and positions, which also reduces occlusions and inaccuracies. As more detailed information is available at a specific moment in time, the speed and accuracy of object recognition, hand and body tracking, surface mapping, and/or digital reconstruction can be improved. By further example, such collaboration can provide more effective and efficient mapping of space, surfaces, objects, gestures, and users.

Systems of the present disclosure can provide head-mountable devices with different input and output capabilities. Such differences can lead the head-mountable devices to provide the corresponding users with somewhat different experiences despite operating in a shared environment. However, the outputs provided by one head-mountable device can be indicated on another head-mountable device so that the users are aware of the characteristics of each other's experience. Where different head-mountable devices provide different sensing capabilities, the sensors of one head-mountable device can contribute to the detections of the other to provide more accurate and detailed outputs, such as object recognition, avatar generation, hand and body tracking, and the like.

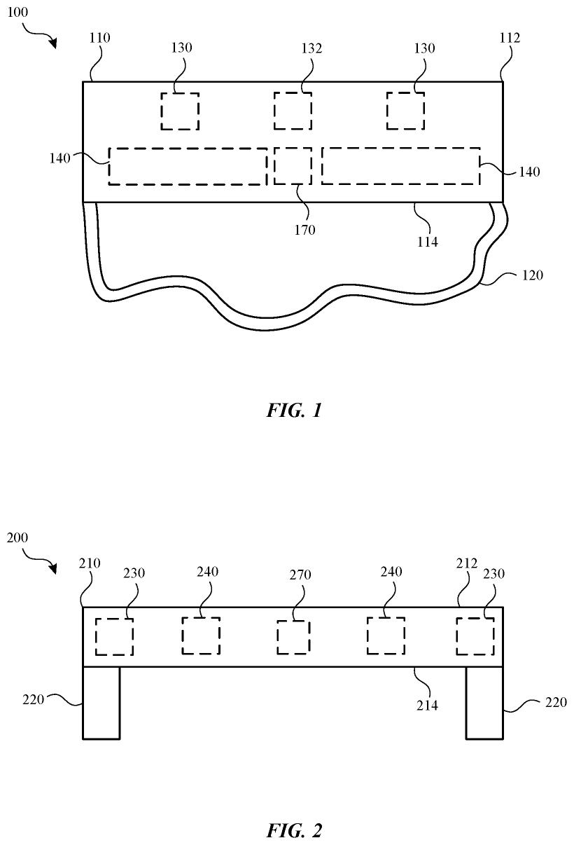

These and other embodiments are discussed below with reference to FIGS. 1-19. However, those skilled in the art will readily appreciate that the detailed description given herein with respect to these Figures is for explanatory purposes only and should not be construed as limiting.

According to some embodiments, for example as shown in FIG. 1, a first head-mountable device 100 includes a frame 110. The frame 110 can be worn on a head of a user. The frame 110 can be positioned in front of the eyes of a user to provide information within a field of view of the user. The frame 110 can provide nose pads and/or other portions to rest on a user's nose, forehead, cheeks, and/or other facial features.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the first head-mountable device 100, as discussed further herein. While several components are shown within the frame 110, it will be understood that some or all of these components can be located anywhere within or on the first head-mountable device 100. For example, one or more of these components can be positioned within a head engager 120 and/or the frame 110 of the first head-mountable device 100.

The frame 110 can optionally be supported on a user's head with a head engager 120. As depicted in FIG. 1, the head engager 120 can optionally wrap around or extend along opposing sides of a user's head. It will be appreciated that other configurations can be applied for securing the first head-mountable device 100 to a user's head. For example, one or more bands, straps, belts, caps, hats, or other components can be used in addition to or in place of the illustrated components of the first head-mountable device 100.

The frame 110 can include and/or support one or more cameras 130. The cameras 130 can be positioned on or near an outer side 112 of the frame 110 to capture images of views external to the first head-mountable device 100. As used herein, an outer side of a portion of a head-mountable device is a side that faces away from the user and/or towards an external environment. The captured images can be used for display to the user or stored for any other purpose.

The first head-mountable device 100 can include one or more external sensors 132 for tracking features of or in an external environment. For example, the first head-mountable device 100 can include image sensors, depth sensors, thermal (e.g., infrared) sensors, and the like. By further example, a depth sensor can be configured to measure a distance (e.g., range) to an object via stereo triangulation, structured light, time-of-flight, interferometry, and the like. Additionally or alternatively, external sensors 132 can include or operate in concert with cameras 130 to capture and/or process an image based on one or more of hue space, brightness, color space, luminosity, and the like.

The first head-mountable device 100 can include one or more internal sensors 170 for tracking features of the user wearing the first head-mountable device 100. For example, an internal sensor 170 can be a user sensor to perform facial feature detection, facial movement detection, facial recognition, eye tracking, user mood detection, user emotion detection, voice detection, etc. By further example, the internal sensor can be a bio-sensor for tracking biometric characteristics, such as health and activity metrics.

The first head-mountable device 100 can include displays 140 that provide visual output for viewing by a user wearing the first head-mountable device 100. One or more displays 140 can be positioned on or near an inner side 114 of the frame 110. As used herein, an inner side of a portion of a head-mountable device is a side that faces toward the user and/or away from the external environment.

According to some embodiments, for example as shown in FIG. 2, another head-mountable device having different components, features, and/or functions can be provided for user by another user. In some embodiments, a second head-mountable device 200 includes a frame 210. The frame 210 can be worn on a head of a user. The frame 210 can be positioned in front of the eyes of a user to provide information within a field of view of the user. The frame 210 can provide nose pads and/or other portions to rest on a user's nose, forehead, cheeks, and/or other facial features.

The frame 210 can provide structure around a peripheral region thereof to support any internal components of the frame 210 in their assembled position. For example, the frame 210 can enclose and support various internal components (including for example integrated circuit chips, processors, memory devices and other circuitry) to provide computing and functional operations for the second head-mountable device 200, as discussed further herein. While several components are shown within the frame 210, it will be understood that some or all of these components can be located anywhere within or on the second head-mountable device 200. For example, one or more of these components can be positioned within a head engager 220 and/or the frame 210 of the second head-mountable device 200.

The frame 210 can optionally be supported on a user's head with a head engager 220. As depicted in FIG. 2, the head engager 220 optionally include earpieces for wrapping around or otherwise engaging or resting on a user's ears. It will be appreciated that other configurations can be applied for securing the second head-mountable device 200 to a user's head. For example, one or more bands, straps, belts, caps, hats, or other components can be used in addition to or in place of the illustrated components of the second head-mountable device 200.

The frame 210 can include and/or support one or more cameras 230. The cameras 230 can be positioned on or near an outer side 212 of the frame 210 to capture images of views external to the second head-mountable device 200. The captured images can be used for display to the user or stored for any other purpose.

The first head-mountable device 100 can include one or more internal sensors 170 for tracking features of the user wearing the first head-mountable device 100.

The second head-mountable device 200 can include displays 240 that provide visual output for viewing by a user wearing the second head-mountable device 200. One or more displays 240 can be positioned on or near an inner side 214 of the frame 210.

Referring now to both FIGS. 1 and 2, the first head-mountable device 100 and the second head-mountable device 200 can provide different features, components, and/or functions. For example, one of the first head-mountable device 100 and the second head-mountable device 200 can provide a component that is not provided by the other of the first head-mountable device 100 and the second head-mountable device 200. By further example, while the first head-mountable device 100 can provide one or more external sensors 132, the second head-mountable device 200 can omit such an external sensor. By further example, while the first head-mountable device 100 can provide one or more internal sensors 170, the second head-mountable device 200 can omit an internal sensor. As such, one of the first head-mountable device 100 and the second head-mountable device 200 can provide greater sensing capabilities than the other.

In some embodiments, components common to both head-mountable devices can be different in one or more features, capabilities, and/or characteristics. For example, the cameras 130 of the first head-mountable device 100 can have greater resolution, field of view, image quality, and/or lowlight performance compared to the cameras 230 of the second head-mountable device 200.

By further example, the displays 140 of the first head-mountable device 100 can have greater resolution, field of view, image quality compared to the displays 240 of the second head-mountable device 200. In some embodiments, the displays 140 can be different types of displays, including opaque displays and transparent or translucent displays.

For example, displays 140 of the first head-mountable device 100 can be opaque displays, and the cameras 130 capture images or video of the physical environment, which are representations of the physical environment. The first head-mountable device 100 composites the images or video with virtual objects and presents the composition on the opaque display 140. A person, using the system, indirectly views the physical environment by way of the images or video of the physical environment, and perceives the virtual objects (where applicable) superimposed over the physical environment. As used herein, a video of the physical environment shown on an opaque display is called “pass-through video,” meaning a system uses one or more image sensor(s) to capture images of the physical environment and can, in some operations, use those images in presenting an augmented reality (AR) environment on the opaque display. An augmented reality (AR) environment refers to a simulated environment in which one or more virtual objects are superimposed over a physical environment, or a representation thereof.

In some embodiments, rather than an opaque display (e.g., display 140), the second head-mountable device 200 may have a transparent or translucent display 240. The transparent or translucent display 240 may have a medium through which light representative of images is directed to a person's eyes. The display 240 may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. For example, the second head-mountable device 200 presenting an augmented reality (AR) environment may have a transparent or translucent display 240 through which a person may directly view the physical environment. The second head-mountable device 200 may be configured to present virtual objects on the transparent or translucent display 240, so that a person, using the second head-mountable device 200, perceives the virtual objects superimposed over the physical environment.

Additionally or alternatively, other types of head-mountable devices can be used with or as one of the first head-mountable device 100 and/or the second head-mountable device 200. Such types of electronic systems enable a person to sense and/or interact with various computer-generated reality environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment.

A physical environment relates to a physical world that people, such as users of head-mountable devices, can interact with and/or sense without necessarily requiring the aid of an electronic device, such as the head-mountable device. A computer-generated reality environment relates to a partially or wholly simulated environment that people sense and/or interact with the assistance of an electronic device, such as the head-mountable device. Computer-generated reality can include, for example, mixed reality and virtual reality. Mixed realities can include, for example, augmented reality and augmented virtuality. Electronic devices that enable a person to sense and/or interact with various computer-generated reality environments can include, for example, head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), tablets, smartphones, and desktop/laptop computers. A head-mountable device can have an integrated opaque display, have a transparent or translucent display, or be configured to accept an external opaque display from another device, such as a smartphone.

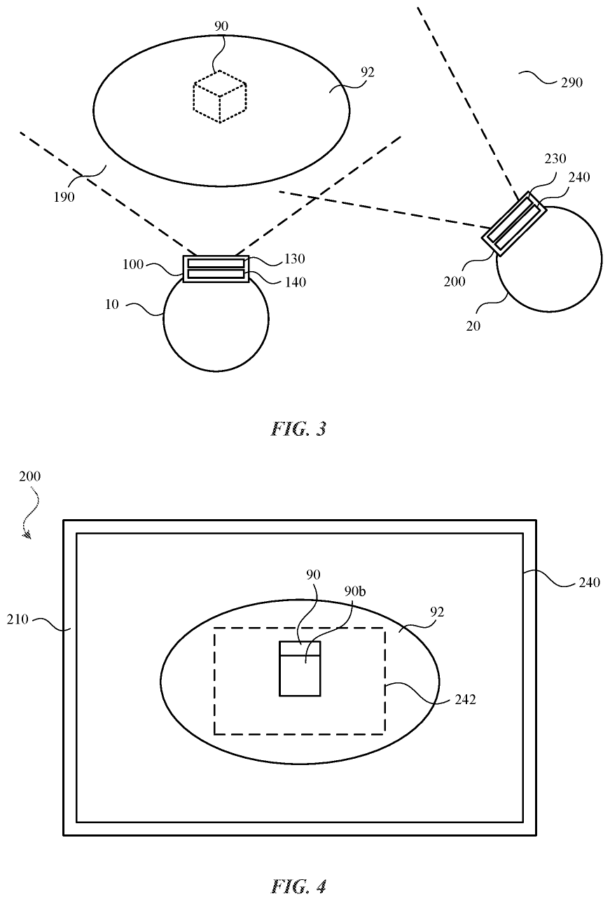

Referring now to FIG. 3, multiple users can each be wearing a corresponding head-mountable device that has a field of view. As shown in FIG. 3, within a first user 10 can wear a first head-mountable device 100, and a second user 20 can wear a second head-mountable device 200. It will be understood that the system can include any number of users and corresponding head-mountable devices. The head-mountable devices can be provided with communication links between any pair of head-mountable devices and/or other devices (e.g., external devices) for sharing data.

The first head-mountable device 100 can have a first field of view 190 (e.g. from camera 130), and the second head-mountable device 200 can have a second field of view 290 (e.g. from camera 230). The fields of view can overlap at least partially, such that an object (e.g., virtual object 90 and/or physical object 92) is within a field of view of more than one of the head-mountable devices. It will be understood that virtual objects (e.g., virtual object 90) need not be captured by a camera but can be within an output field of view (e.g., from displays 140 and/or 240) that is based on images captured by the corresponding camera. The first head-mountable device 100 and the second head-mountable device 200 can each be arranged to capture the object from a different perspective, such that different portions, surfaces, sides, and/or features of the virtual object 90 and/or physical object 92 can be observed and/or displayed by the different head-mountable devices.

Referring now to FIGS. 4-6, the head-mountable devices can provide corresponding outputs that reflect the perspectives thereof and optionally provide information regarding other experiences provided by other head-mountable devices. Such information can be provided within graphical user interfaces. Regarding the graphical user interfaces described herein, not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

As shown in FIG. 4, the head-mountable device 200 can operate its display 240 to provide a graphical user interface 242. As described herein, the display 240 can be a translucent or transparent display that permits light from an external environment to be passed therethrough to the user. As such, the physical object 92 can be visible within the display 240 whether it is within or outside the graphical user interface 242. The graphical user interface 242 can further provide a view to the virtual object 90. In some embodiments, the virtual object 90 can be visible only through the graphical user interface 242 as an item rendered as if located within the external environment, but not visible through portions of the display 240 that do not include the graphical user interface 242. Where the graphical user interface 242 occupies less space (e.g., has a smaller field of view) than that of the display 240, the user's perception of the virtual object 90 can be limited. As further shown in FIG. 4, the view of the virtual object 90 and/or the physical object 92 can be based on the perspective of the head-mountable device 200. As such, the display 240 and/or the graphical user interface 242 can provide a view to particular sides 90b and/or portions of the virtual object 90 and/or the physical object 92.

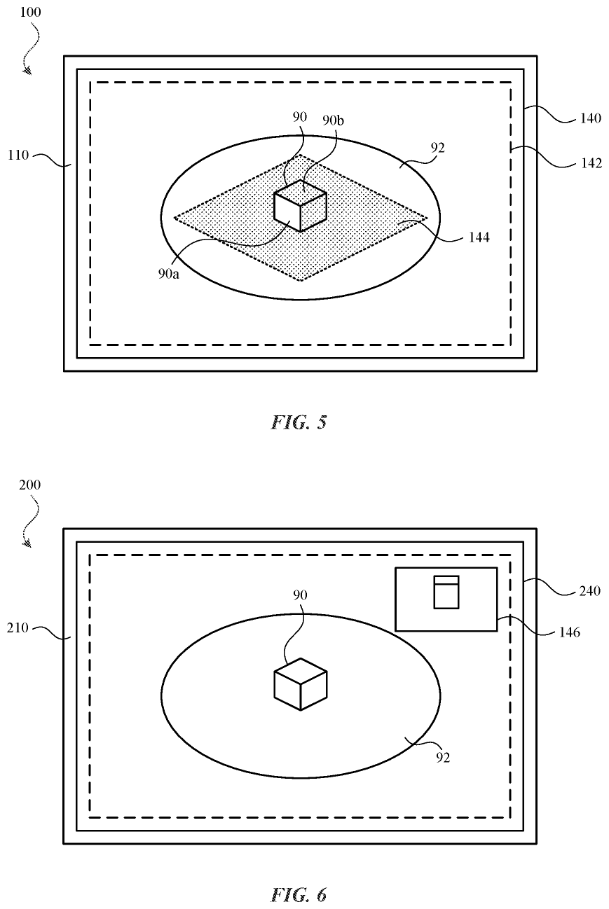

As shown in FIG. 5, the head-mountable device 100 can operate its display 140 to provide a graphical user interface 142. As described herein, the display 140 can be an opaque display that generates images based on views captured by a camera and/or other information, such as virtual objects rendered as if located within the external environment. As such, both the physical object 92 and the virtual object 90 can be visible within the display 140 as part of the graphical user interface 142. The graphical user interface 142 can occupy a substantial portion (e.g., up to all) of the display 140. As such, it can provide a broader field of view than that of the graphical user interface 242. As further shown in FIG. 5, the view of the virtual object 90 and/or the physical object 92 can be based on the perspective of the head-mountable device 100. As such, the display 140 and/or the graphical user interface 142 can provide a view to particular sides and are portions of the virtual object 90 and/or the physical object 92.

In some embodiments, as shown in FIG. 5, the graphical user interface 142 can further include one or more indicators to help a user recognize the perspective experienced by the other user wearing the second head-mountable device 200. Such an indicator 144 can be displayed simultaneously with the view of the virtual object 90 and/or the physical object 92. For example, the indicator 144 can show which sides 90a and 90b and/or portions of the virtual object 90 and/or the physical object 92 are being observed by the user wearing the second head-mountable device 200. For example, the indicator 144 can be provided at certain external surfaces of the virtual object 90 and/or the physical object 92. For example, the indicator 144 can include a highlighting, glow, shadow, reflection, outline, border, text, icons, symbols, emphasis, duplication, aura, and/or animation provided at a vicinity of the sides 90b and/or portions of the virtual object 90 and/or the physical object 92 that are within the field of view provided by the second head-mountable device 200. Other sides 90a and/or portions of the virtual object 90 and/or the physical object 92 can omit such an indicator 144. The user wearing the head-mountable device 100 can, by observing the graphical user interface 142, recognize any differences between the user's own perspective and the other user's perspective by the indicator 144.

In some embodiments, as shown in FIG. 6, the graphical user interface 142 can further include one or more windowed views to help a user recognize the perspective experienced by the other user wearing the second head-mountable device. Such a windowed view 146 can be displayed simultaneously with the view of the virtual object 90 and/or the physical object 92. For example, the windowed view 146 can show a duplicate of the user interface of the second head-mountable device (see graphical user interface 242 of FIG. 4) and/or another output of its display. As such, the user wearing the head-mountable device 100 can, by observing the graphical user interface 142, directly observe an output provided to the other user by the second head-mountable device.

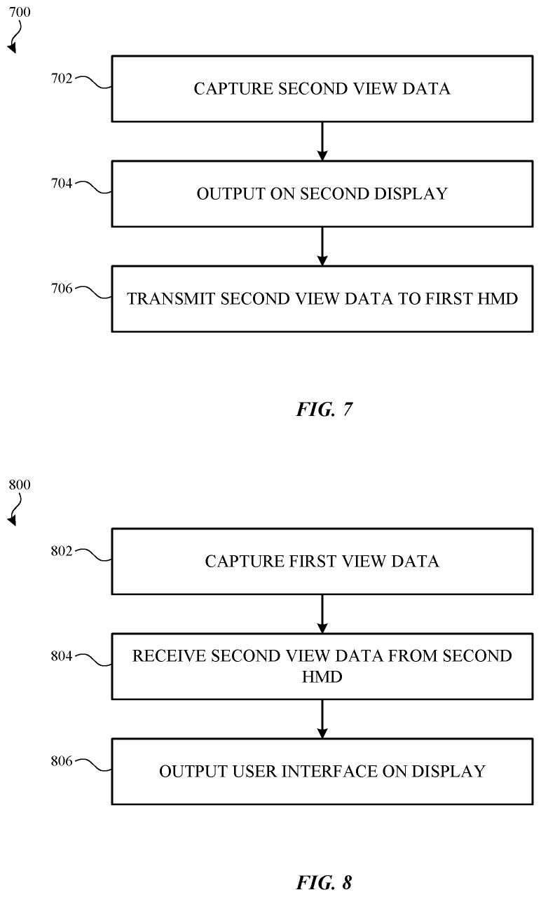

FIG. 7 illustrates a flow diagram for operating a head-mountable device. For explanatory purposes, the process 700 is primarily described herein with reference to the head-mountable device 200 of FIGS. 2-4. However, the process 700 is not limited to the head-mountable device 200 of FIGS. 2-4, and one or more blocks (or operations) of the process 700 may be performed by different head-mountable devices and/or one or more other devices. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

In operation 702, a (e.g., second) head-mountable device can capture second view data corresponding to an observed perspective of the second head-mountable device. For example, the second view data can include information relating to one or more images captured by a camera of the second head-mountable device. In some embodiments, the second view data can be received from another device that can be used to determine a position and/or orientation of the second head-mountable device within a space. Accordingly, the second view data can include information relating to the position and/or orientation of the second head-mountable device with respect to a physical object and/or a virtual object to be rendered. The second view data can further include information relating to one or more physical objects observed by the second head-mountable device.

In operation 704, the second head-mountable device can provide an output on a display thereof. For example, the display can output a view of one or more virtual and/or physical objects with the display and/or a graphical user interface provided thereon, such as that illustrated in FIG. 4. The output provided on the display can be based at least in part on the second view data captured by the second head-mountable device, which can thereby determine the sides and/or portions of virtual and/or physical objects that are observable based on the output provided by the display.

In operation 706, the second view data can be transmitted to a first head-mountable device. In this regard, the second view data can include data that was used by the second head-mountable device for providing an output on the second display in operation 704. Additionally or alternatively, the second view data can include information, images, and/or other data that is generated based on the original second view data. For example, the transmitted second view data can include a direct feed of the output provided on the display.

FIG. 8 illustrates a flow diagram for operating a head-mountable device. For explanatory purposes, the process 800 is primarily described herein with reference to the head-mountable device 100 of FIGS. 1, 3, and 5-6. However, the process 800 is not limited to the head-mountable device 100 of FIGS. 1, 3, and 5-6, and one or more blocks (or operations) of the process 800 may be performed by different head-mountable devices and/or one or more other devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

In operation 802, another (e.g., first) head-mountable device can capture first view data corresponding to an observed perspective of the first head-mountable device. For example, the first view data can include information relating to one or more images captured by a camera of the first head-mountable device. In some embodiments, the first view data can be received from another device that can be used to determine a position and/or orientation of the first head-mountable device within a space. Accordingly, the first view data can include information relating to the position and/or orientation of the first head-mountable device with respect to a physical object and/or a virtual object to be rendered. The first view data can further include information relating to one or more physical objects observed by the first head-mountable device.

In operation 804, the second view data can be received from the second head-mountable device. The second view data can be used, for example with the first view data, by the first head-mountable device to determine the position and/or orientation of the second head-mountable device with respect to the first head-mountable device and/or a virtual or physical object. The second view data can further be used to determine information relating to the perspective of the second head-mountable device. For example, the perspective of the second head-mountable device can be determined to further determine sides and/or portions of physical and/or virtual objects that are observed by the second head-mountable device and/or output to a user wearing the second head-mountable device.

In operation 806, the first head-mountable device can provide an output on a display thereof. For example, the display can output a view of one or more virtual and/or physical objects with the display and/or a graphical user interface provided thereon, such as that illustrated in FIG. 5 or 6. The output provided on the display can be based at least in part on the first view data captured by the head-mountable device. The output can also include information relating to the second head-mountable device, such as indicators and/or windows views described herein. Such additional information can be determined based on the second view data, such that the first head-mountable device determines the sides and/or portions of virtual and/or physical objects that are observable to and/or output by the second head-mountable device.

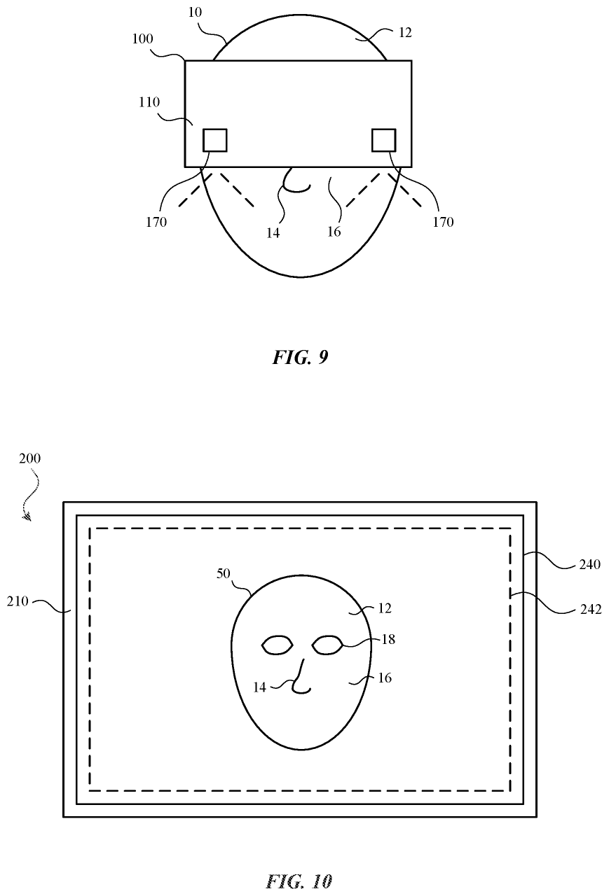

Referring now to FIG. 9, sensors of a head-mountable device can be used to detect facial features of a person wearing the head-mountable device. Such detections can be used to determine how an avatar representing the person should be generated for output to other users.

As shown in FIG. 9, the head-mountable device 100 can include one or more internal sensors 170 each configured to detect a characteristic of the user's face. For example, the internal sensors 170 can include one or more eye sensors to capture and/or process an image of an eye 18 (not shown in FIG. 9) and perform analysis based on one or more of hue space, brightness, color space, luminosity, and the like. By further example, the internal sensors 170 can include one or more capacitive sensors 172 configured to detect a nose 14 of the user 10. The capacitive sensors 172 can detect contact, proximity, and/or distance to the nose of the user 10. By further example, the internal sensors 170 can include one or more temperature sensors (e.g., infrared sensors, thermometers, thermocouples, and the like) 174 configured to detect a temperature of the face of the user. By further example, the internal sensors 170 can include brow cameras configured to detect a brow 12 of the user and/or process an image of an eyebrow and perform analysis based on one or more of hue space, brightness, color space, luminosity, and the like. By further example, the internal sensors 170 can include one or more depth sensors 178 configured to detect a shape of a face of the user 10 (e.g., cheeks 16). It will be understood that internal sensors 170 can include sensors provided at an exterior of the head-mountable device 100 to detect facial features of the user. These and/or other sensors can be positioned to detect features described herein with respect to the user's mouth, cheeks, jaw, chin, ears, temples, forehead, and the like. Such information can be used (e.g., by another head-mountable device) to generate an avatar having the detected features. By further example, any number of other sensors can be provided to perform facial feature detection, facial movement detection, facial recognition, eye tracking, user mood detection, user emotion detection, user gestures, voice detection, and the like. The sensors can include force sensors, contact sensors, capacitive sensors, strain gauges, resistive touch sensors, piezoelectric sensors, cameras, pressure sensors, photodiodes, and/or other sensors.

Referring now to FIG. 10, another head-mountable device can output an avatar based on detected features. FIG. 10 illustrates rear views of a second head-mountable device operable by a user, the head-mountable device providing a user interface 242, according to some embodiments of the present disclosure. The display 240 can provide the user interface 242. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

The graphical user interface 142 provided by the display 140 can include an avatar 50 that represents the user 10 wearing the first head-mountable device 100. It will be understood that the avatar 50 need not include a representation of the first head-mountable device 100 worn by the user 10. Thus, despite wearing head-mountable devices, each user can observe an avatar that includes facial features that would otherwise be covered by the head-mountable device. The avatar 50 can be a virtual yet realistic representation of a person based on detections made by the head-mountable device worn by that person. Such detections can be made with respect to features of the person, such as the user's brows 12, nose 14, cheeks 16, and/or eyes 18. One or more of the features of the avatar 50 can be based on detections performed by the first head-mountable device worn thereby. Additionally or alternatively, one or more of the features of the avatar 50 can be based on selections made by the person. For example, previous to or concurrent with output of the avatar 50, the person represented by the avatar 50 can select and/or modify one or more of the features. For example, the person can select a hair color that does not correspond to their actual hair color. Some features can be static, such as hair color, eye color, ear shape, and the like. One or more features can be dynamic, such as eye gaze direction, eyebrow location, mouth shape, and the like. In some embodiments, detected information regarding facial features (e.g., dynamic features) can be mapped to static features in real-time to generate and display the avatar 50. In some cases, the term “real-time” is used to indicate that the results of the extraction, mapping, rendering, and presentation are performed in response to each motion of the person and can be presented substantially immediately. The observer may feel as if they are looking at the person when looking at the avatar 50.

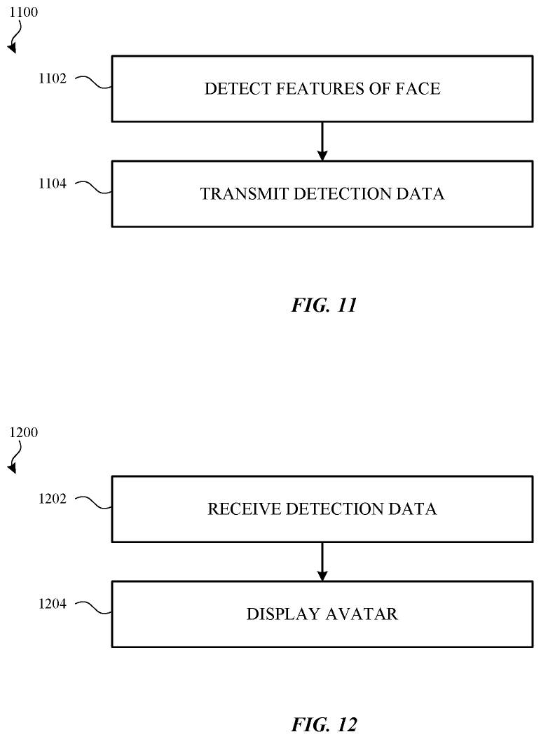

FIG. 11 illustrates a flow diagram for operating a head-mountable device. For explanatory purposes, the process 1100 is primarily described herein with reference to the head-mountable device 100 of FIG. 9. However, the process 1100 is not limited to the head-mountable device 100 of FIG. 9, and one or more blocks (or operations) of the process 1100 may be performed by different head-mountable devices and/or one or more other devices. Further for explanatory purposes, the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

In operation 1102, a (e.g., first) head-mountable device can detect features of a face of a user wearing the first head-mountable device. In some embodiments, the detections performed by the first head-mountable device can be sufficient to generate an avatar corresponding to the user.

In operation 1104, detection data captured by one or more sensors of the first head-mountable device can be transmitted to another head-mountable device. The detection data can be used to generate an avatar to be output to the user wearing the second head-mountable device.

FIG. 12 illustrates a flow diagram for operating a head-mountable device. For explanatory purposes, the process 1200 is primarily described herein with reference to the head-mountable device 200 of FIG. 10. However, the process 1200 is not limited to the head-mountable device 200 of FIG. 10, and one or more blocks (or operations) of the process 1200 may be performed by different head-mountable devices and/or one or more other devices. Further for explanatory purposes, the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

In operation 1202, another (e.g., second) head-mountable device can receive detection data from the first head-mountable device. In some embodiments, the detection data can be raw data generated by one or more sensors of the first head-mountable device, such that the second head-mountable device must process the detection data to generate the avatar. In some embodiments, the detection data can be processed data that is based on raw data generated by the one or more sensors. Such process data can include information that is readily used to generate an avatar. Accordingly, processing can be performed by either the first head-mountable device or the second head-mountable device.

In operation 1204, the second head-mountable device can display an avatar to a graphical user interface on a display thereof. The avatar can be updated based on additional detections performed by the first head-mountable device and/or detection data received from the first head-mountable device.

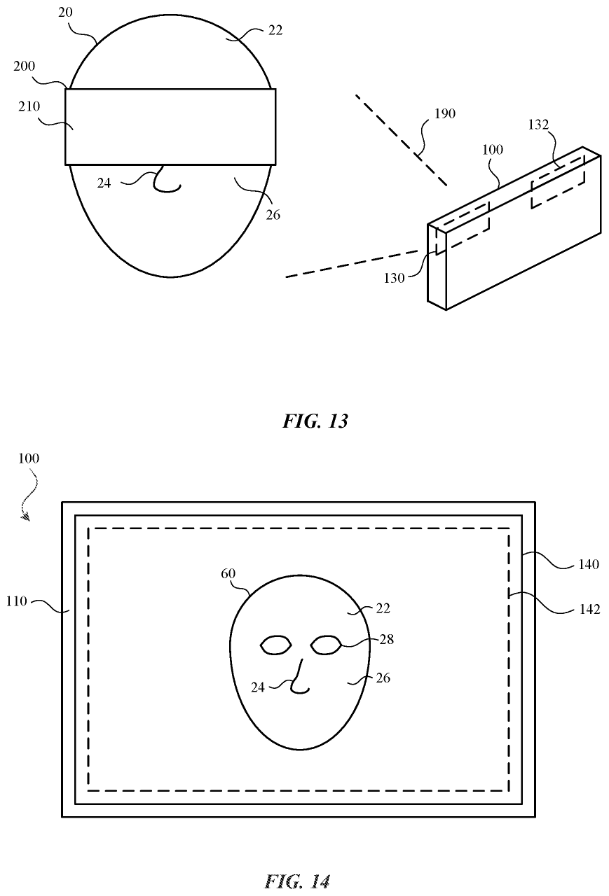

Referring now to FIG. 13, sensors of a head-mountable device can be used to detect facial features of a person wearing a different head-mountable device. Such detections can be used to determine how an avatar representing the person should be generated for output to other users. Such cooperatives detections can be useful when at least one of the head-mountable devices has fewer sensing capabilities. Accordingly, the other head-mountable device can help by providing new or additional detections for use by either one of the head-mountable devices to generate an avatar.

As shown in FIG. 13, head-mountable devices can be worn and operated by different individuals, who can then participate in a shared environment. Within that environment, each user can observe an avatar representing the other individuals participating in the shared environment. As further shown in FIG. 13, a first head-mountable device 100 can face in a direction of the second head-mountable device 200. Cameras 130 and/or other external sensors 132 of the first head-mountable device 100 can capture a view of the user 20 and/or the second head-mountable device 200 and detect facial features. For example, the cameras 130 and/or other external sensors 132 of the first head-mountable device 100 can operate with respect to the user 20 as did the sensors described in FIG. 9 with respect to the user 10. Such detections can be transmitted to the second head-mountable device 200 and/or proceed by the first head-mountable device 100. It will be understood that the transmitted detections can be any information that is usable to generate an avatar, including raw data regarding the detections and/or processed data that includes instructions on how to generate an avatar. The head-mountable device 100 receiving the detections can output and avatar based on the received information. The output of the avatar itself can further be influenced by detections made by the receiving head-mountable device, as described further herein.

Referring now to FIG. 10, the head-mountable device 100 can output an avatar based on detected features. FIG. 10 illustrates rear views of a second head-mountable device operable by a user, the head-mountable device providing a user interface 142, according to some embodiments of the present disclosure. The display 140 can provide the user interface 142. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

The graphical user interface 142 provided by the display 140 can include an avatar 60 that represents the user 20 wearing the second head-mountable device 200. It will be understood that the avatar 60 need not include a representation of the second head-mountable device 200 worn by the user 20. The avatar 60 can be a virtual yet realistic representation of a person based on detections made by the head-mountable device worn by another person. Such detections can be made with respect to features of the person, such as the person's brows 22, nose 24, cheeks 26, and/or eyes 28. One or more of the features of the avatar 60 can be based on detections performed by the first head-mountable device 100 worn by another user, particularly where the sensing capabilities of the second head-mountable device 200 are deemed inadequate for avatar generation.

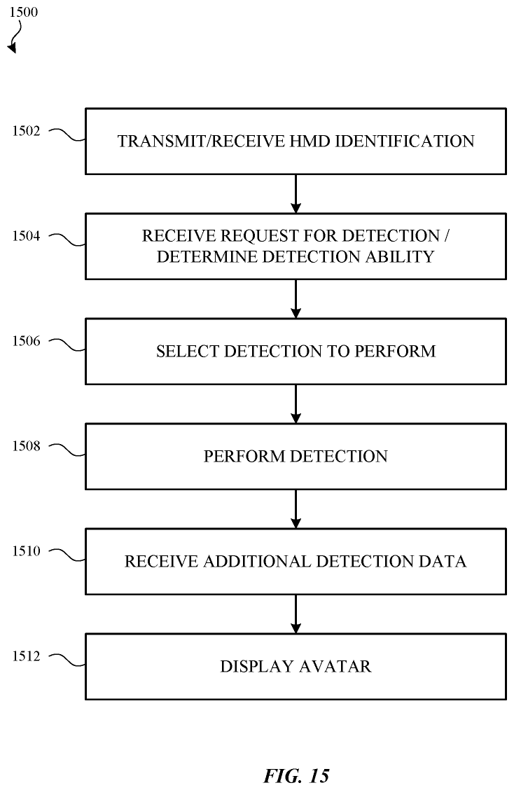

FIG. 15 illustrates a flow diagram for operating a head-mountable device. For explanatory purposes, the process 1500 is primarily described herein with reference to the head-mountable device 100 of FIGS. 13 and 14. However, the process 1500 is not limited to the head-mountable device 100 of FIGS. 13 and 14, and one or more blocks (or operations) of the process 1500 may be performed by different head-mountable devices and/or one or more other devices. Further for explanatory purposes, the blocks of the process 1500 are described herein as occurring in serial, or linearly. However, multiple blocks of the process 1500 may occur in parallel. In addition, the blocks of the process 1500 need not be performed in the order shown and/or one or more blocks of the process 1500 need not be performed and/or can be replaced by other operations.

In operation 1502, head-mountable devices operating together can identify themselves to each other. For example, each head-mountable device can transmit an identification of itself, and each head-mountable device can receive an identification of another head-mountable device. The identification can include make, model, and/or other specifications of each head-mountable device. For example, the identification can indicate whether a given head-mountable device has or lacks certain components, features, and/or functions. By further example, the identification can indicate a detection ability of a given head-mountable device.

In operation 1504, the first head-mountable device can receive a request for detection. Additionally or alternatively, the first head-mountable device can determine a detection ability of another (e.g., second) head-mountable device. Based on the request or the determine detection ability, the first head-mountable device may determine that it can perform detections to assist with avatar generation. In some embodiments, the second head-mountable device may lack sensors required to detect facial features of the user wearing the second head-mountable device. In some embodiments, the second head-mountable device may request detections whether or not it contains its own detection ability.

In operation 1506, the first head-mountable device can select a detection to perform. The selection can be based on a request for detection. For example, the request for detection may indicate a region of the face to be detected, and the first head-mountable device can select a detection that corresponds to the request. Additionally or alternatively, the selection can be based on a determine detection ability of the second head-mountable device. For example, the first head-mountable device can determine that the second head-mountable device is unable to detect certain facial features (based on inadequate sensing ability, target outside the field of view, and/or target obstructed from view). In such cases, the first head-mountable device can select detections that corresponds to the undetected facial features.

In operation 1508, the first head-mountable device can detect features of a face of a user wearing the second head-mountable device. In some embodiments, the detections performed by the first head-mountable device can be sufficient to generate an avatar corresponding to the user.

In operation 1510, the first head-mountable device can receive additional detection data from the second head-mountable device. It will be understood that the receipt of such additional detection data is optional, particularly where the second head-mountable device has inadequate or missing detection ability. In some embodiments, the additional detection data is received along with the request for detection, wherein the request for detection corresponds to facial features not represented in the additional detection data.

In operation 1512, the first head-mountable device can display an avatar to a graphical user interface on a display thereof. The avatar can be updated based on additional detections performed by the first head-mountable device and/or detection data received from the second head-mountable device.

Accordingly, both the first head-mountable device and the second head-mountable device can provide outputs including avatars of another user. Such avatars can be generated even when one of the head-mountable devices lacks a detection ability to perform its own complete set of detections. As such, the capabilities of one head-mountable device can be sufficient to provide both head-mountable devices with sufficient data to generate avatars.

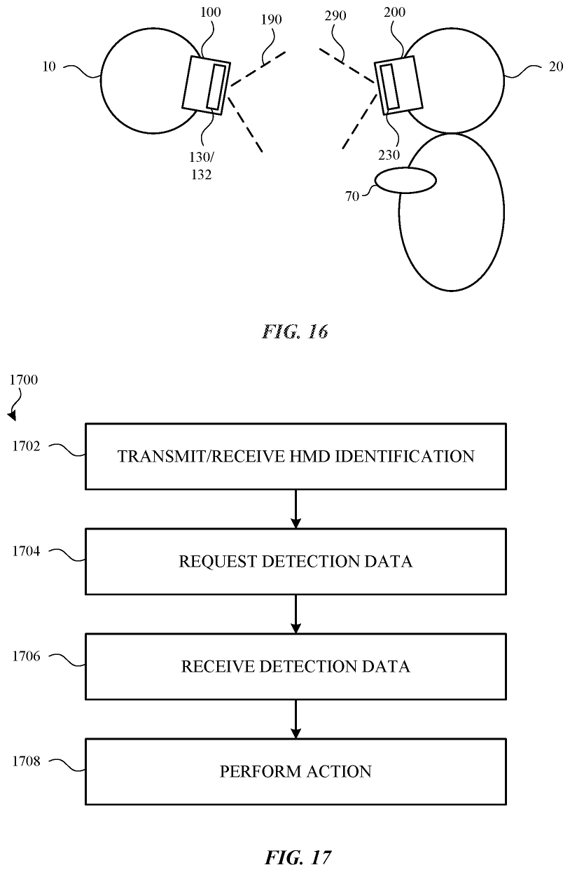

Referring now to FIG. 16, head-mountable devices can operate cooperatively to perform a greater range of detections than would be possible for only one of the head-mountable devices. In some embodiments, data relating to the users and the head-mountable devices can also be captured, processed, and/or generated by any one or more of the head-mountable devices. It will be understood that the users themselves can be within a field of view of one of the head-mountable devices and outside a field of view of another one of the head-mountable devices, including the head-mountable device worn by that user. In such cases, data relating to any given user may be more effectively captured by a head-mountable device worn by a user other than the given user. For example, at least a portion of the second user 20 and/or the second head-mountable device 200 can be within the first field of view 190 of the first head-mountable device 100. Accordingly, the first head-mountable device 100 can capture, process, and/or generate data regarding the second user 20 and/or the second head-mountable device 200 and transmit such data to one or more other head-mountable devices (e.g., the second head-mountable device 200). Where such data relating to the user can be used by the head-mountable device that does not contain that user within its field of view, the data can be shared with that head-mountable device.

As shown in FIG. 16, the first head-mountable device 100 and the second head-mountable device 200 can each be arranged to detect objects from different perspectives. In some embodiments, the objects can include other portions of one of the user, such as a limb 70 (e.g., arm, hand, fingers, leg, foot, toes, etc.) of a second user 20. In some embodiments, different portions, surfaces, sides, and/or features of the limb 70 of the second user 20 can be observed from the first head-mountable device 100. In some embodiments, the limb 70 of the second user 20 can be observed only by the first head-mountable device 100, such as when the limb 70 is outside the field of view 290 of the second head-mountable device 200. In some embodiments, the limb 70 of the second user 20 can be observed only by the first head-mountable device 100, such as when the limb 70 is obstructed yet within the field of view 290 of the second head-mountable device 200. Accordingly, the first head-mountable device 100 can be operated to detect features of the limb 70 of the second user 20.

In some embodiments, head-mountable devices can operate in concert to perform gesture recognition. For example, data can be captured, processed, and are generated by one or more of the head-mountable devices where the data includes captured views of a user. Gesture recognition can involve the detection of a position, orientation, and/or motion of a user (e.g., limbs, hands, fingers, etc.). Such detections can be enhanced when based on views captured from multiple perspectives. Such perspectives can include views from separate head-mountable devices, including head-mountable devices worn by a user other than the user making the gesture. Data based on these views can be shared between or among head-mountable devices and/or an external device for processing and gesture recognition. Any processing data can be shared with the head-mountable device worn by the user making the gesture and corresponding actions can be performed.

In some embodiments, head-mountable devices can operate in concert to perform object recognition. For example, data can be captured, processed, and/or generated by one or more of the head-mountable devices to determine a characteristic of an object. A characteristic can include an identity, name, type, reference, color, size, shape, make, model, or other feature detectable by one or more of the head-mountable devices. Once determined, the characteristic can be shared and one or more of the head-mountable devices can optionally provide a representation of the object to the corresponding user via a display thereof. Such representations can include any information relating to the characteristic, such as labels, textual indications, graphical features, and/or other information. Additionally or alternatively, a representation can include a virtual object displayed on the display as a substitute for the physical object. As such, identified objects from a physical environment can be replaced and/or augmented with virtual objects.

In some embodiments, head-mountable devices can operate in concert to environment mapping. For example, data can be captured, processed, and are generated by one or more of the head-mountable devices to map the contours of an environment. Each head-mountable device can capture multiple views from different positions and orientations with respect to the environment. The combined data can include more views than are captured by either one of the head-mountable devices.

FIG. 17 illustrates a flow diagram for operating a head-mountable device. For explanatory purposes, the process 1700 is primarily described herein with reference to the head-mountable device 200 of FIG. 16. However, the process 1700 is not limited to the head-mountable device 200 of FIG. 16, and one or more blocks (or operations) of the process 1700 may be performed by different head-mountable devices and/or one or more other devices. Further for explanatory purposes, the blocks of the process 1700 are described herein as occurring in serial, or linearly. However, multiple blocks of the process 1700 may occur in parallel. In addition, the blocks of the process 1700 need not be performed in the order shown and/or one or more blocks of the process 1700 need not be performed and/or can be replaced by other operations.

In operation 1702, head-mountable devices operating together can identify themselves to each other. For example, each head-mountable device can transmit an identification of itself, and each head-mountable device can receive an identification of another head-mountable device. The identification can include make, model, and/or other specifications of each head-mountable device. For example, the identification can indicate whether a given head-mountable device has or lacks certain components, features, and/or functions. By further example, the identification can indicate a detection ability of a given head-mountable device.

In operation 1704, the second head-mountable device can request detection data from another (e.g., first) head-mountable device. Such a request can be determined based on a known detection ability of the second head-mountable device and/or a known detection ability of the first head-mountable device. For example, where a limb to be detected is outside a field of view of the second head-mountable device and/or the second head-mountable device lacks a sensor for detecting the limb, such a request can be made. In some embodiments, the second head-mountable device determines whether a first head-mountable device includes a detection ability and/or a position and/or orientation to detect to the limb and makes a request accordingly.

In operation 1706, the second head-mountable device can receive detection data from the first head-mountable device. In some embodiments, the detection data can be raw data generated by one or more sensors of the first head-mountable device, such that the second head-mountable device must process the detection data to determine an action to perform. In some embodiments, the detection data can be processed data that is based on raw data generated by the one or more sensors. Such process data can include information that is readily used to determine an action to perform. Accordingly, processing can be performed by either the first head-mountable device or the second head-mountable device.

In operation 1708, the second head-mountable device can determine an action to perform and/or perform the action. The determination and/or the action itself can be based on the detection data received from the first head-mountable device. For example, where the first head-mountable device detects gestures from the limb that corresponds to user input (e.g., user instruction or user command), the second head-mountable device can perform an action corresponding to the user input.

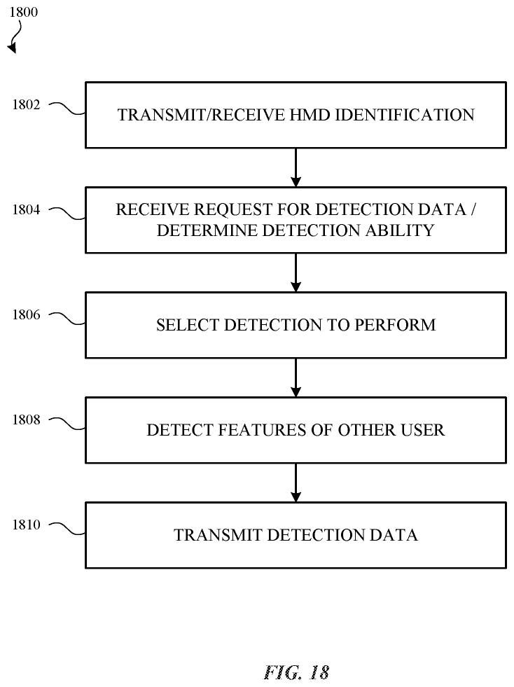

FIG. 18 illustrates a flow diagram for operating a head-mountable device. For explanatory purposes, the process 1800 is primarily described herein with reference to the head-mountable device 100 of FIG. 16. However, the process 1800 is not limited to the head-mountable device 100 of FIG. 16, and one or more blocks (or operations) of the process 1800 may be performed by different head-mountable devices and/or one or more other devices. Further for explanatory purposes, the blocks of the process 1800 are described herein as occurring in serial, or linearly. However, multiple blocks of the process 1800 may occur in parallel. In addition, the blocks of the process 1800 need not be performed in the order shown and/or one or more blocks of the process 1800 need not be performed and/or can be replaced by other operations.

In operation 1802, head-mountable devices operating together can identify themselves to each other. For example, each head-mountable device can transmit an identification of itself, and each head-mountable device can receive an identification of another head-mountable device. The identification can include make, model, and/or other specifications of each head-mountable device. For example, the identification can indicate whether a given head-mountable device has or lacks certain components, features, and/or functions. By further example, the identification can indicate a detection ability of a given head-mountable device.

In operation 1804, the first head-mountable device can receive a request for detection. Additionally or alternatively, the first head-mountable device can determine a detection ability of another (e.g., second) head-mountable device. Based on the request or the determine detection ability, the first head-mountable device may determine that it can perform detections to assist with action determination. In some embodiments, the second head-mountable device may lack sensors required to detect gestures of the user (e.g., limb) wearing the second head-mountable device. In some embodiments, the second head-mountable device may request detections whether or not it contains its own detection ability.

In operation 1806, the first head-mountable device can select a detection to perform. The selection can be based on a request for detection. For example, the request for detection may indicate a limb to be detected, and the first head-mountable device can select a detection that corresponds to the request. Additionally or alternatively, the selection can be based on a determine detection ability of the second head-mountable device. For example, the first head-mountable device can determine that the second head-mountable device is unable to detect a limb (based on inadequate sensing ability, target outside the field of view, and/or target obstructed from view). In such cases, the first head-mountable device can select detections that corresponds to the undetected limb.

In operation 1808, the first head-mountable device can detect features of a limb of the user wearing the second head-mountable device. In some embodiments, the detections performed by the first head-mountable device can be sufficient to determine an action to be performed by the second head-mountable device.

In operation 1810, the first head-mountable device can transmit detection data to the second head-mountable device (i.e., received in operation 1706 of process 1700).

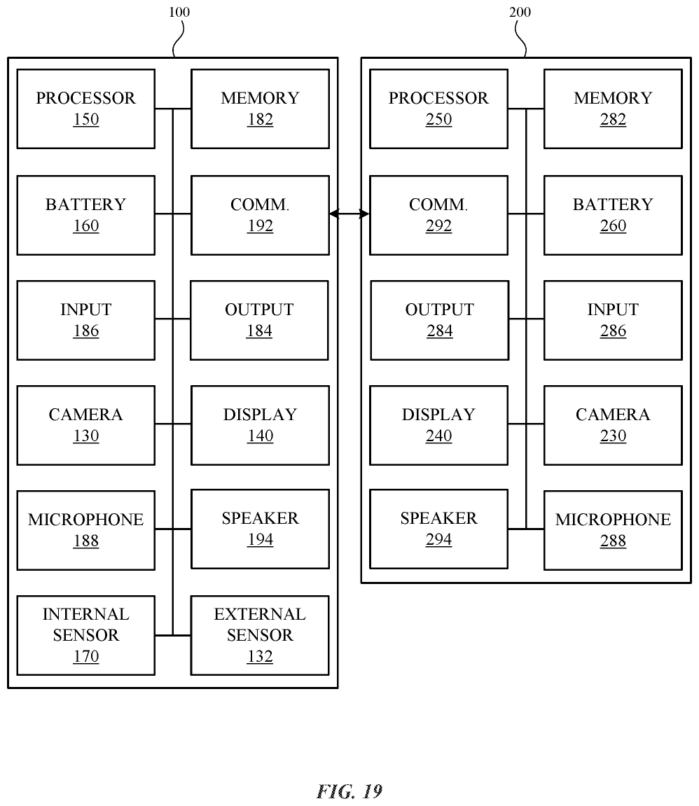

Referring now to FIG. 19, components of head-mountable devices can be operably connected to provide the performance described herein. FIG. 19 shows a simplified block diagram of illustrative head-mountable devices 100 and 200 in accordance with one embodiment of the invention. It will be understood that additional components, different components, or fewer components than those illustrated may be utilized within the scope of the subject disclosure.

As shown in FIG. 19, the first head-mountable device 100 can include, within or coupled to the frame 110, a processor 150 (e.g., control circuitry) with one or more processing units that include or are configured to access a memory 152 having instructions stored thereon. The instructions or computer programs may be configured to perform one or more of the operations or functions described with respect to the first head-mountable device 100. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 152 can store electronic data that can be used by the first head-mountable device 100. For example, the memory 152 can store electrical data or content such as, for example, audio and video files, documents and applications, device settings and user preferences, timing and control signals or data for the various modules, data structures or databases, and so on. The memory 152 can be configured as any type of memory. By way of example only, the memory 152 can be implemented as random access memory, read-only memory, Flash memory, removable memory, or other types of storage elements, or combinations of such devices.

The first head-mountable device 100 can further include a display 140 for displaying visual information for a user. The display 140 can provide visual (e.g., image or video) output, as described further herein. The first head-mountable device 100 can further include a camera 130 for capturing a view of an external environment, as described herein. The view captured by the camera can be presented by the display 140 or otherwise analyzed to provide a basis for an output on the display 140.

The first head-mountable device 100 can include an input component 186 and/or output component 184, which can include any suitable component for receiving user input, providing output to a user, and/or connecting head-mountable device 100 to other devices. The input component 186 can include buttons, keys, or another feature that can act as a keyboard for operation by the user. Other suitable components can include, for example, audio/video jacks, data connectors, or any additional or alternative input/output components.

The first head-mountable device 100 can include the microphone 188. The microphone 188 can be operably connected to the processor 150 for detection of sound levels and communication of detections for further processing.

The first head-mountable device 100 can include the speakers 194. The speakers 194 can be operably connected to the processor 150 for control of speaker output, including sound levels.

The first head-mountable device 100 can include communications interface 192 for communicating with one or more servers or other devices using any suitable communications protocol. For example, communications interface 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications interface 192 can also include an antenna for transmitting and receiving electromagnetic signals.

The first head-mountable device 100 can include one or more other sensors, such as internal sensors 170 and/or external sensor 132. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include the camera 130 which can capture image-based content of the outside world.

The first head-mountable device 100 can include a battery 160, which can charge and/or power components of the first head-mountable device 100. The battery can also charge and/or power components connected to the first head-mountable device 100.

As further shown in FIG. 19, the second head-mountable device 200 can include, within or coupled to the frame 210, a processor 250 (e.g., control circuitry) with one or more processing units that include or are configured to access a memory 252 having instructions stored thereon. The instructions or computer programs may be configured to perform one or more of the operations or functions described with respect to the second head-mountable device 200. The processor 250 can be implemented as any electronic device capable of processing, receiving, or transmitting data or instructions. For example, the processor 250 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 252 can store electronic data that can be used by the second head-mountable device 200. For example, the memory 252 can store electrical data or content such as, for example, audio and video files, documents and applications, device settings and user preferences, timing and control signals or data for the various modules, data structures or databases, and so on. The memory 252 can be configured as any type of memory. By way of example only, the memory 252 can be implemented as random access memory, read-only memory, Flash memory, removable memory, or other types of storage elements, or combinations of such devices.

The second head-mountable device 200 can further include a display 240 for displaying visual information for a user. The display 240 can provide visual (e.g., image or video) output, as described further herein. The second head-mountable device 200 can further include a camera 230 for capturing a view of an external environment, as described herein. The view captured by the camera can be presented by the display 240 or otherwise analyzed to provide a basis for an output on the display 240.

The second head-mountable device 200 can include an input component 286 and/or output component 284, which can include any suitable component for receiving user input, providing output to a user, and/or connecting head-mountable device 200 to other devices. The input component 286 can include buttons, keys, or another feature that can act as a keyboard for operation by the user. Other suitable components can include, for example, audio/video jacks, data connectors, or any additional or alternative input/output components.

The second head-mountable device 200 can include the microphone 288. The microphone 288 can be operably connected to the processor 250 for detection of sound levels and communication of detections for further processing.

The second head-mountable device 200 can include the speakers 294. The speakers 294 can be operably connected to the processor 250 for control of speaker output, including sound levels.

The second head-mountable device 200 can include communications interface 292 for communicating with the first head-mountable device 100 (e.g., via communication interface 192) and/or one or more servers or other devices using any suitable communications protocol. For example, communications interface 292 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications interface 292 can also include an antenna for transmitting and receiving electromagnetic signals.

The second head-mountable device 200 can include one or more other sensors, such as internal sensors 270 and/or external sensor 232. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include the camera 230 which can capture image-based content of the outside world.

The second head-mountable device 200 can include a battery 260, which can charge and/or power components of the second head-mountable device 200. The battery can also charge and/or power components connected to the second head-mountable device 200.

Accordingly, embodiments of the present disclosure include head-mountable devices with different input and output capabilities. Such differences can lead the head-mountable devices to provide the corresponding users with somewhat different experiences despite operating in a shared environment. However, the outputs provided by one head-mountable device can be indicated on another head-mountable device so that the users are aware of the characteristics of each other's experience. Where different head-mountable devices provide different sensing capabilities, the sensors of one head-mountable device can contribute to the detections of the other to provide more accurate and detailed outputs, such as object recognition, avatar generation, hand and body tracking, and the like.

Various examples of aspects of the disclosure are described below as clauses for convenience. These are provided as examples, and do not limit the subject technology.

Clause A: a head-mountable device comprising: a first camera configured to capture first view data; a first display for providing a first graphical user interface comprises a first view of an object, the first view being based on the first view data; and a communication interface configured to receive second view data from an additional head-mountable device, the additional head-mountable device comprising a second display for providing a second graphical user interface showing a second view of the object, the second view data indicating a feature of the second view of the object, wherein the first graphical user interface further comprises an indicator located at the object and being based on the second view data.

Clause B: a head-mountable device comprising: a communication interface configured to receive, from an additional head-mountable device, an identification of the additional head-mountable device; a processor configured to: determine a detection ability of the additional head-mountable device; and select a detection to perform based on the detection ability; an external sensor configured to perform the selected detection with respect to a portion of a face; and a display configured to output an avatar based on the detection of the face.

Clause C: a head-mountable device comprising: a first camera configured to capture a first view; a communication interface configured to receive, from an additional head-mountable device, second view data indicating a second view captured by a second camera of the additional head-mountable device; and a processor configured to: determine when a limb is within the first view and outside the second view; and when the limb is within the first view and outside the second view, operate the first camera to detect a feature of the limb, wherein the communication interface is further configured to transmit, to the additional head-mountable device, detection data based on the detected feature of the limb.

Clause D: a head-mountable device comprising: a communication interface configured to: receive, from an additional head-mountable device, an identification of the additional head-mountable device; and a processor configured to: determine, based on identification of the additional head-mountable device, a detection ability of the additional head-mountable device; and select, based on the detection ability, a detection to request, wherein the communication interface is further configured to: transmit, to the additional head-mountable device, a request for detection data; and receive, from the additional head-mountable device, the detection data.

Clause E: a head-mountable device comprising: a first camera configured to capture a first view; a processor configured to: determine, based on the first view, when a limb is not within the first view; and determine when an additional head-mountable device, comprising a second camera, is arranged to capture a second view of the limb; and a communication interface configured to: transmit, to the additional head-mountable device, a request for detection data based on the second view of the limb; and receive, from the additional head-mountable device, the detection data.

One or more of the above clauses can include one or more of the features described below. It is noted that any of the following clauses may be combined in any combination with each other, and placed into a respective independent clause, e.g., clause A, B, C, D, or E.

Clause 1: the first display is an opaque display; and the second display is a translucent display providing a view to a physical environment.

Clause 2: the additional head-mountable device further comprises a second camera, wherein the first camera has a resolution that is greater than a resolution of the second camera.

Clause 3: the additional head-mountable device further comprises a second camera, wherein the first camera has a field of view that is greater than a field of view of the second camera.

Clause 4: the first display has a first size; and the second display has a second size, smaller than the first size.

Clause 5: the first graphical user interface has a first size; and the second graphical user interface has a second size, smaller than the first size.

Clause 6: the second view shows a second side of the object; and the first view shows a first side of the object and at least a portion of the second side of the object, wherein the indicator is applied to the portion of the second side of the object in the first view.

Clause 7: the indicator comprises at least one of a highlighting, glow, shadow, reflection, outline, border, text, icons, symbols, emphasis, duplication, aura, or animation.

Clause 8: the object is a virtual object.

Clause 9: the object is a physical object in a physical environment.

Clause 10: the external sensor is a camera.

Clause 11: the external sensor is a depth sensor, wherein the additional head-mountable device does not comprise a depth sensor.

Clause 12: the communication interface is further configured to receive detection data from the additional head-mountable device, the detection data being based on an additional detection of the face performed by the additional head-mountable device, wherein the avatar is further based on the detection data.

Clause 13: the detection ability comprises an indication of whether the portion of the face is within a field of view of a sensor of the additional head-mountable device.

Clause 14: determining when the limb is within the first view and outside the second view is based on a detected position and orientation of the additional head-mountable device within the first view and detected position of the limb within the first view.

Clause 15: determining when the limb is within the first view and outside the second view is based on view data received from the additional head-mountable device.

Clause 16: the communication interface is further configured to: transmit an identification of the head-mountable device to the additional head-mountable device; and receive a request for the detection data from the additional head-mountable device.

Clause 17: the detection data comprises an instruction for the additional head-mountable device to perform an action in response to a gesture made by the limb and detected by the first camera.

As described herein, aspects of the present technology can include the gathering and use of certain data. In some instances, gathered data can include personal information or other data that can uniquely identify or be used to locate or contact a specific person. It is contemplated that the entities responsible for the collection, storage, analysis, disclosure, transfer, or other use of such personal information or other data will comply with well-established privacy practices and/or privacy policies. The present disclosure also contemplates embodiments in which users can selectively block the use of or access to personal information or other data, which can be managed to minimize risks of unintentional or unauthorized access or use.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a first camera configured to capture first view data;
a first display configured to provide a first graphical user interface showing a first view of an object, the first view being based on the first view data; and
a communication interface configured to receive second view data from an additional head-mountable device, the additional head-mountable device comprising a second display configured to provide a second graphical user interface showing a second view of the object, the second view data indicating a feature of the second view of the object,
wherein the first display is further configured to provide the first graphical user interface showing an indicator located at the object and being based on the second view data.

2. The head-mountable device of claim 1, wherein:
the first display is an opaque display; and
the second display is a translucent display providing a view to a physical environment.

3. The head-mountable device of claim 1, wherein the additional head-mountable device further comprises a second camera, wherein the first camera has a resolution that is greater than a resolution of the second camera.

4. The head-mountable device of claim 1, wherein the additional head-mountable device further comprises a second camera, wherein the first camera has a field of view that is greater than a field of view of the second camera.

5. The head-mountable device of claim 1, wherein:
the first display has a first size; and
the second display has a second size, smaller than the first size.

6. The head-mountable device of claim 1, wherein:
the first graphical user interface has a first size; and
the second graphical user interface has a second size, smaller than the first size.

7. The head-mountable device of claim 1, wherein:
the second view shows a second side of the object; and
the first view shows a first side of the object and at least a portion of the second side of the object, wherein the indicator is applied to the portion of the second side of the object in the first view.

8. The head-mountable device of claim 1, wherein the indicator comprises at least one of a highlighting, glow, shadow, reflection, outline, border, text, icons, symbols, emphasis, duplication, aura, or animation.

9. The head-mountable device of claim 1, wherein the object is a virtual object.

10. The head-mountable device of claim 1, wherein the object is a physical object in a physical environment.

11. A head-mountable device comprising:
a communication interface configured to receive, from an additional head-mountable device, an identification of the additional head-mountable device;
a processor configured to:
determine a detection ability of the additional head-mountable device; and
select a detection to perform based on the detection ability;
an external sensor configured to perform the selected detection with respect to a portion of a face; and
a display configured to output an avatar based on the detection of the face.

12. The head-mountable device of claim 11, wherein the external sensor is a camera.

13. The head-mountable device of claim 11, wherein the external sensor is a depth sensor, wherein the additional head-mountable device does not comprise a depth sensor.

14. The head-mountable device of claim 11, wherein the communication interface is further configured to receive detection data from the additional head-mountable device, the detection data being based on an additional detection of the face performed by the additional head-mountable device, wherein the avatar is further based on the detection data.

15. The head-mountable device of claim 11, wherein the detection ability comprises an indication of whether the portion of the face is within a field of view of a sensor of the additional head-mountable device.

16. A head-mountable device comprising:
a first camera configured to capture a first view;
a communication interface configured to receive, from an additional head-mountable device, second view data indicating a second view captured by a second camera of the additional head-mountable device; and
a processor configured to:
determine when a limb is within the first view and outside the second view; and
when the limb is within the first view and outside the second view, operate the first camera to detect a feature of the limb,
wherein the communication interface is further configured to transmit, to the additional head-mountable device, detection data based on the detected feature of the limb.

17. The head-mountable device of claim 16, wherein determining when the limb is within the first view and outside the second view is based on a detected position and orientation of the additional head-mountable device within the first view and detected position of the limb within the first view.

18. The head-mountable device of claim 16, wherein determining when the limb is within the first view and outside the second view is based on view data received from the additional head-mountable device.

19. The head-mountable device of claim 16, wherein the communication interface is further configured to:
transmit an identification of the head-mountable device to the additional head-mountable device; and
receive a request for the detection data from the additional head-mountable device.

20. The head-mountable device of claim 16, wherein the detection data comprises an instruction for the additional head-mountable device to perform an action in response to a gesture made by the limb and detected by the first camera.
